(19) United States
(12) Patent Application Publication
(10) Pub. No.: US 2020/0107413 A1
(43) Pub. Date: Apr. 2, 2020

(54) LIGHTING APPARATUS, LAMP, VEHICLE, AND NON-TRANSITORY COMPUTER-READABLE MEDIUM

(71) Applicant: Panasonic Intellectual Property Management Co., Ltd., Osaka (JP)

(72) Inventors: Takashi KAMBARA, Osaka (JP); Toshiya MORIWAKI, Osaka (JP); Masanobu MURAKAMI, Osaka (JP); Masahiko KOIZEKI, Osaka (JP)

(21) Appl. No.: 16/577,342

(22) Filed: Sep. 20, 2019

(30) Foreign Application Priority Data
Sep. 28, 2018 (JP) 2018-186020

(51) Int. Cl. H05B 33/08; B60Q 1/04

(52) U.S. Cl. CPC H05B 33/0815; F21S 45/47; B60Q 1/04; H05B 33/0842

(57) ABSTRACT

A lighting apparatus includes a step-up converter, at least one step-down converter, and a controller. The step-up converter is configured to step up a voltage of a direct-current power supply to obtain an output voltage having a first voltage value and output the output voltage. The at least one step-down converter is configured to step down the output voltage of the step-up converter to have a second voltage value to output a current having a current value according to the second voltage value to a light source. The controller is configured to acquire information about a specification of the light source, control the step-down converter such that the current value becomes a current value according to the specification, and control the step-up converter such that the first voltage value changes in accordance with the specification.

### CROSS-REFERENCE TO RELATED APPLICATION

The present application is based upon and claims the benefit of priority of Japanese Patent Application No. 2018-186020, filed on Sep. 28, 2018, the entire contents of which are incorporated herein by reference.

### TECHNICAL FIELD

The present disclosure generally relates to lighting apparatuses, lamps, vehicles, and non-transitory computer readable media. More specifically, the present disclosure relates to a lighting apparatus configured to output a current to a light source unit, a lamp including the lighting apparatus, a vehicle including the lamp, and a non-transitory computer-readable medium.

### BACKGROUND ART

Document 1 (JP 2018-85241 A) describes a power supply lighting apparatus (lighting apparatus) including a step-up circuit (step-up converter), a step-down circuit (step-down converter), and a controller. The step-up circuit is configured to step up a power supply voltage of a direct-current power supply. The step-down circuit is configured to step down an output voltage of the step-up circuit to output the output voltage to a light source (light source unit). The controller is configured to control the step-up circuit and the step-down circuit.

In the power supply lighting apparatus described in Document 1, the output voltage of the step-up circuit does not change depending on specifications of light sources (that is, the output voltage is constant). Therefore, in order to be compatible with a plurality of light sources based on different specifications, the output voltage of the step-up circuit has to be set to a voltage higher than or equal to the highest one of voltages of the plurality of light sources based on the different specifications. Thus, when the power supply lighting apparatus described in Document 1 adopts a light source with a specification of a low voltage, the output voltage of the step-up circuit is excessively high with respect to a voltage required in accordance with the specification of the light source, so that circuit loss increases. This increases, for example, a heating value, and thus, a heat dissipation unit with high heat dissipation has to be provided. This results in increased size and cost.

### SUMMARY

In view of the foregoing, it is an object of the present disclosure to provide a lighting apparatus which enables circuit loss to be reduced, a lamp including the lighting apparatus, a vehicle including the lamp, and a non-transitory computer-readable medium.

A lighting apparatus according to one aspect of the present disclosure includes a step-up converter, at least one step-down converter, and a controller. The step-up converter is configured to step up a voltage of a direct-current power supply to obtain an output voltage having a first voltage value and output the output voltage. The at least one step-down converter is configured to step down the output voltage of the step-up converter to have a second voltage value to output a current having a current value according to the second voltage value to a light source. The controller is configured to acquire information about a specification of the light source, control the at least one step-down converter such that the current value becomes a current value according to the specification, and control the step-up converter such that the first voltage value varies in accordance with the specification.

A lamp according to one aspect of the present disclosure includes the light source and the lighting apparatus.

A vehicle according to one aspect of the present disclosure includes the lamp and a vehicle body. The lamp is mounted on the vehicle.

A non-transitory computer-readable medium according to one aspect of the present disclosure is a non-transitory computer-readable medium storing a computer program designed to cause at least one processor to execute a step-up conversion process, a step-down conversion process, and a control process. The step-up conversion process is a process of controlling a step-up converter to step up a voltage of a direct-current power supply to obtain an output voltage having a first voltage value and output the output voltage. The step-down conversion process is a process of controlling a step-down converter to step down the output voltage of the step-up conversion process to have a second voltage value to output a current having a current value according to the second voltage value to the light source. The control process is a process of acquiring information about a specification of the light source, controlling the step-down converter such that the current value becomes a current value according to the specification, and controlling the step-up converter such that the first voltage value varies in accordance with the specification.

### BRIEF DESCRIPTION OF THE DRAWINGS

FIG. 1 is a block diagram illustrating a lighting apparatus of a first embodiment;

FIG. 2 is a flowchart illustrating operation of the lighting apparatus;

FIG. 3 is a flowchart illustrating a process in step S3 of FIG. 2;

FIG. 4 is a perspective view illustrating a vehicle on which a lamp including the lighting apparatus is mounted;

FIG. 5 is a view illustrating a relationship between a light source rated current value and a target voltage value of a second variation;

FIG. 6 is a sectional view illustrating a lamp of a third variation;

FIG. 7 is a block diagram illustrating a lighting apparatus of a second embodiment;

FIG. 8A is a view illustrating a relationship between a first light source rated current value and a first target voltage value of the lighting apparatus of the second embodiment;

FIG. 8B is a view illustrating a relationship between a second light source rated current value and a second target voltage value of the lighting apparatus of the second embodiment;

FIG. 9 is a flowchart illustrating operation of the lighting apparatus of the second embodiment; and

FIG. 10 is a flowchart illustrating a process in step S13 of FIG. 9.

### DETAILED DESCRIPTION

Embodiments and variations described below are mere examples of the present disclosure. Therefore, the present disclosure is not limited to the embodiments and variations but may be modified variously without departing from the scope of the present disclosure, even if not including the embodiments and variations, according to a design or the like.

### First Embodiment

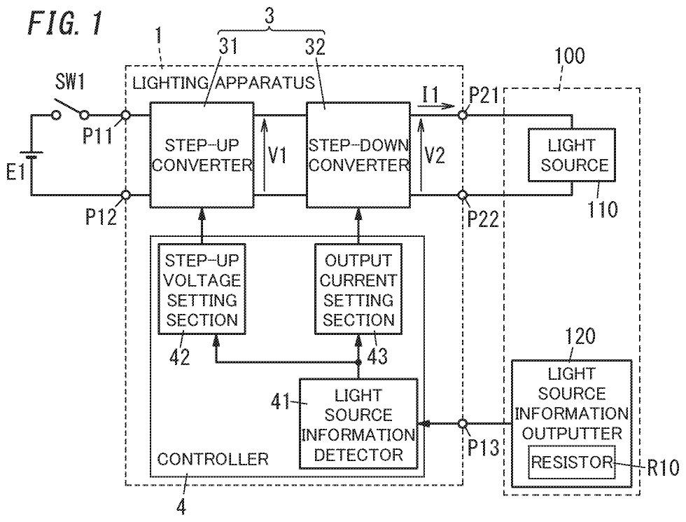

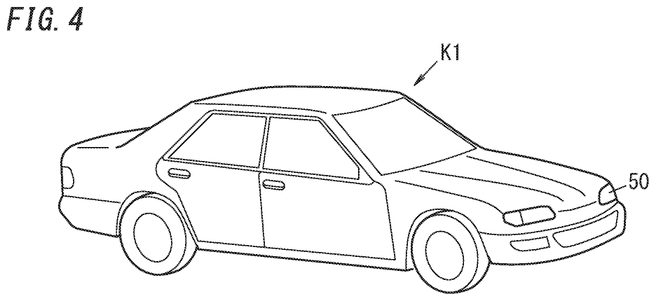

A lighting apparatus 1 of the present embodiment will be described with reference to FIGS. 1 to 4. As illustrated in FIG. 4, the lighting apparatus 1 of the present embodiment in FIG. 1 is adopted in a lamp 50 serving as a headlamp mounted on a vehicle K1 such as an automobile. As illustrated in FIG. 1, the lighting apparatus 1 turns on a light source unit 100 (load).

First of all, the light source unit 100 serving as the load of the lighting apparatus 1 will be described.

The light source unit 100 includes a light source 110 and a light source information outputter 120 as illustrated in FIG. 1. The light source 110 includes a semiconductor light-emitting element such as an LED. The light source information outputter 120 is configured to output light source information denoting a light-emitting property of the light source 110 when supplied with electric power.

The light source 110 includes, for example, a plurality of LEDs. The plurality of LEDs are connected in series or in parallel. The light source information outputter 120 includes, for example, a resistor R10. The light source 110 is, in order of light-emitting property, ranked into a corresponding one of a plurality of levels, each of which predetermines the resistance value of the resistor R10 included in the light source information outputter 120. For example, the light-emitting property of each light source 110 is determined during manufacturing or the like, and a resistor R10 having a resistance value corresponding to the light-emitting property and serving as the light source information outputter 120 is provided to the light source unit 100.

When a current is output to the light source information outputter 120, a voltage according to the resistance value of the resistor R10 is generated between both ends of the resistor R10, and the value of this voltage serves as the light source information corresponding to the light-emitting property of the light source 110. As used herein, the term “light source information” refers to information corresponding to the light-emitting property of the light source 110, and it is possible to determine the light-emitting property of the light source 110 based on the light source information. The light-emitting property of the light source 110 is, for example, information denoting the specification of the light source 110 (specification of the light source unit 100). The specification of the light source 110 includes information about at least one of an input current, an input voltage, and input power to the light source 110. Note that the information about the input current includes information of a light source rated current value of the light source 110. In the present embodiment, the specification of the light source 110 includes, as information about the input current to the light source 110, information about the light source rated current value.

As illustrated in FIG. 1, the lighting apparatus 1 includes a first input terminal P11 to a third input terminal P13, a first output terminal P21, and a second output terminal P22. As used herein, the term “terminal” does not have to be a component (terminal) for connecting an electric wire and the like but may be, for example, a lead of an electronic component or part of a conductor included in a circuit board.

The first input terminal P11 and the second input terminal P12 are electrically connected to both ends of a direct-current power supply E1. Specifically, the first input terminal P11 is electrically connected via a power supply switch SW1 to the positive electrode of the direct-current power supply E1, and the second input terminal P12 is electrically connected to the negative electrode of the direct-current power supply E1. The direct-current power supply E1 is a battery mounted on the vehicle K1 (see FIG. 4). The direct-current power supply E1 has a power supply voltage of, for example, 12 V [volt].

The power supply switch SW1 is a switch for supplying or interrupting electric power from the direct-current power supply E1 to a power converter 3. The power supply switch SW1 is provided to, for example, a driver seat of the vehicle K1. A driver switches on or off the power supply switch SW1, which allows the light source 110 to be switched on/off. In an ON state of the power supply switch SW1, the power supply voltage of the direct-current power supply E1 is output to the power converter 3. In an OFF state of the power supply switch SW1, outputting of the power supply voltage from the direct-current power supply E1 to the power converter 3 is interrupted.

Note that in the present embodiment, the power supply switch SW1 is connected between the positive electrode of the direct-current power supply E1 and the terminal P11 of the lighting apparatus 1, and the power supply switch SW1 is turned on and off to directly turn on and off power supply from the direct-current power supply E1 to the lighting apparatus 1. Alternatively, a relay in place of the power supply switch SW1 may be connected between the positive electrode of the direct-current power supply E1 and the terminal P11 of the lighting apparatus 1, and the power supply switch SW1 may be turned on and off to turn on and off the relay, and turning on and off the relay may turn on and off the power supply from the direct-current power supply E1 to the lighting apparatus 1.

The third input terminal P13 is electrically connected to the light source information outputter 120 of the light source unit 100. The first output terminal P21 and the second output terminal P22 are electrically connected to the light source 110. Specifically, the light source 110 is electrically connected between the first output terminal P21 and the second output terminal P22.

The lighting apparatus 1 includes the power converter 3 and a controller 4.

The power converter 3 is electrically connected via the first input terminal P11 and the second input terminal P12 to the direct-current power supply E1. The power converter 3 is a DC/DC converter configured to perform direct current conversion of direct-current power supplied from the direct-current power supply E1. The power converter 3 supplies the direct-current power to the light source 110 to turn on the light source 110. The power converter 3 includes a step-up converter 31 and a step-down converter 32.

The step-up converter 31 is, for example, a step-up chopper circuit including an inductor, a switching element, a diode, a driver IC, and other components (not shown). The step-up converter 31 is electrically connected via the first input terminal P11 and the second input terminal P12 to the direct-current power supply E1. The switching element of the step-up converter 31 is turned on/off to step up the power supply voltage (e.g., 12 V) of the direct-current power supply E1 to obtain an output voltage V1 having a first voltage value, and the step-up converter 31 outputs the output voltage V1 to the step-down converter 32. The driver IC turns on/off the switching element in response to control by the controller 4 to perform control such that the output voltage V1 of the step-up converter 31 has the first voltage value. Note that the driver IC is provided in the step-up converter 31 in the present embodiment but may be provided outside the step-up converter 31.

The step-down converter 32 is, for example, a step-down chopper circuit also including an inductor, a switching element, a diode, a driver IC, and other components (not shown). Each of two output ends of the step-down converter 32 is electrically connected to a corresponding one of the first output terminal P21 and the second output terminal P22. The switching element of the step-down converter 32 is turned on/off to step down the output voltage V1 of the step-up converter 31 from the first voltage value to a second voltage value to obtain an output voltage V2, and the step-down converter 32 outputs the output voltage V2 to the light source 110. Thus, the step-down converter 32 outputs, to the light source 110, an output current I1 having a first current value according to the second voltage value. The driver IC turns on/off the switching element in response to the control by the controller 4 to perform control such that the output voltage V2 of the step-down converter 32 has the second voltage value, thereby controlling the output current I1 of the step-down converter 32 to have the first current value. Note that the driver IC is provided in the step-down converter 32 in the present embodiment but may be provided outside the step-down converter 32. Moreover, the step-down converter 32 may be a series regulator circuit, and in this case, the step-down converter 32 controls the magnitude of the impedance of a regulator element so as to control the output current I1.

The controller 4 is a computer system (e.g., microcontroller) including a processor and memory as main components (not shown). The computer system executes a program stored in the memory to realize functions as the controller 4. The program may be stored in the memory in advance, provided via a telecommunications network such as the Internet, or provided by a storage medium such as a memory card storing the program.

The controller 4 controls the power converter 3 (the step-up converter 31 and the step-down converter 32). Specifically, the controller 4 controls the step-up converter 31 such that the first voltage value as the value of the output voltage V1 changes in accordance with the specification of the light source 110. When the specification of the light source 110 is information representing, for example, a light source rated current value of the light source 110, the controller 4 controls the step-up converter 31 such that the output voltage V1 decreases as the light source rated current value of the light source 110 increases, and the output voltage V1 increases as the light source rated current value decreases. The controller 4 also controls the step-down converter 32 such that the output current I1 has a current value according to the specification of the light source 110.

More specifically, the controller 4 sets, in accordance with the light source rated current value of the light source 110, a target voltage value serving as a set value of the first voltage value (i.e., target voltage value for the output voltage V1). The controller 4 controls the switching element of the step-up converter 31 such that the value (first voltage value) of the output voltage V1 of the step-up converter 31 becomes the target voltage value. That is, the controller 4 performs constant voltage control of the step-up converter 31 such that the output voltage V1 of the step-up converter 31 has the target voltage value. The controller 4 also sets, in accordance with the light source rated current value of the light source 110, a target current value serving as a set value of the first current value (i.e., target current value for the output current I1). The controller 4 controls the switching element of the step-down converter 32 such that the value (first current value) of the output current I1 of the step-down converter 32 becomes the target current value. That is, the controller 4 performs constant current control of the step-down converter 32 such that the output current I1 of the step-down converter 32 has the target current value.

The controller 4 includes a light source information detector 41, a step-up voltage setting section 42, and a output current setting section 43.

The light source information detector 41 acquires the light source information from the light source information outputter 120 of the light source unit 100. For example, the light source information detector 41 outputs a current to the light source information outputter 120, measures a voltage value of a voltage generated at the resistor R10 in the light source information outputter 120, and acquires the voltage value as the light source information. The light source information detector 41 has a correspondence relationship between the voltage value and the specification of the light source 110. The correspondence relationship is given as, for example, a function formula or a correspondence table. The light source information detector 41 acquires, from the correspondence relationship, information about the specification corresponding to the voltage value thus measured. In the present embodiment, the specification of the light source 110 is information representing the light source rated current value of the light source 110. Thus, the light source information detector 41 acquires, based on the correspondence relationship, the information about the light source rated current value of the light source 110 from the voltage value thus detected. The light source information detector 41 outputs the information about the light source rated current value thus acquired to the output current setting section 43 and the step-up voltage setting section 42.

The step-up voltage setting section 42 generates (sets), based on the information about the light source rated current value input from the light source information detector 41, the target voltage value for the output voltage V1 of the step-up converter 31 (i.e., the set value of the first voltage value). The step-up voltage setting section 42 outputs information about the target voltage value thus generated to the step-up converter 31 as a control signal. Meanwhile, in the step-up converter 31, for example, the driver IC controls turning on/off of the switching element such that the output voltage V1 of the step-up converter 31 has the target voltage value.

The target voltage value is obtained based on the value of a maximum output voltage output to the light source 110, the value of a maximum output power output to the light source 110, and the light source rated current value of the light source 110 (the value of the input current). The value of the maximum output voltage and the value of the maximum output power are set in the controller 4 in advance. Thus, it is possible to obtain the target voltage value according to the light source rated current value.

Specifically, a voltage value obtained by dividing the value of the maximum output power by the value of the output current is defined as a maximum light source voltage value. The maximum light source voltage value is a voltage value of a voltage output to the light source 110 at the time of the maximum output power and when a current having the light source rated current value is output to the light source 110. That is, the maximum light source voltage value is the voltage value of a voltage obtained by back calculation from the maximum output power. The target voltage value for the output voltage V1 is set as a value obtained by adding a prescribed voltage value (e.g., 10 V) to the smaller of the value of the maximum output voltage or the value of the maximum light source voltage value. Thus, the target voltage value for the output voltage V1 may be set to a value higher than a voltage according to the specification (e.g., light source rated current value) of the light source 110 by a prescribed voltage value. Thus, it is possible to set the target voltage value to a voltage value which is not excessively high with respect to the specification (e.g., light source rated current value) of the light source unit 100. Note that the prescribed voltage value is, for example, 10 V, but when the step-up voltage setting section 42 is a series regulator circuit, the prescribed voltage value may be a voltage value lower than 10 V (e.g., 1.2 V).

The output current setting section 43 generates (sets), based on the information about the light source rated current value input from the light source information detector 41, the target current value for the output current I1 of the step-down converter 32 (i.e., the set value of the first current value). The target current value may be, for example, a value equal to the light source rated current value. The output current setting section 43 outputs, as a control signal, the target current value thus generated to the step-down converter 32. Meanwhile, in the step-down converter 32, for example, the driver IC controls turning on/off of the switching element such that the output current I1 of the step-down converter 32 has the target current value.

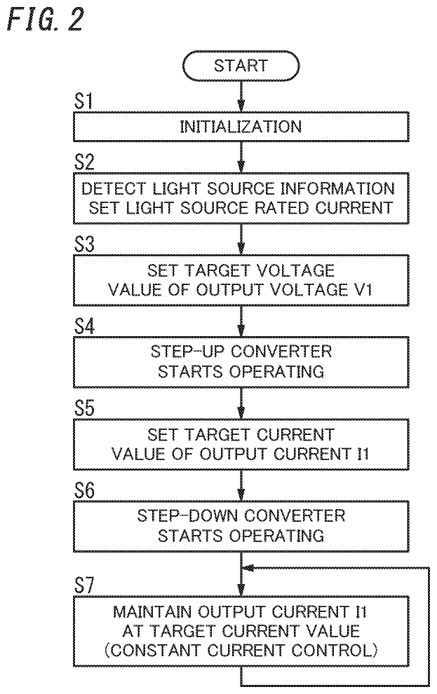

Next, with reference to FIG. 2, operation of the lighting apparatus 1 will be described.

When a driver of the vehicle K1 turns on the power supply switch SW1 to output electric power from the direct-current power supply E1 to the lighting apparatus 1, the controller 4 performs initialization processing (step S1). Then, the light source information detector 41 detects the light source information from the light source information outputter 120 of the light source unit 100 and acquires the light source rated current value from the light source information thus detected. Then, the light source information detector 41 outputs the light source rated current value to the step-up voltage setting section 42 and the output current setting section 43 (step S2).

Then, the step-up voltage setting section 42 obtains, based on the light source rated current value from the light source information detector 41, the target voltage value for the output voltage V1 and outputs, as a control signal, the target voltage value thus obtained to the step-up converter 31 (step S3). When receiving the target voltage value from the step-up voltage setting section 42, the step-up converter 31 starts operating to control the switching element such that the output voltage V1 has the target voltage value (step S4). Thus, the output voltage V1 changes in accordance with the specification of the light source 110. As a result, it is possible to reduce cases where the output voltage V1 of the step-up converter 31 is a voltage excessively high with respect to the specification of the light source 110.

Then, the output current setting section 43 obtains, based on the light source rated current value from the light source information detector 41, the target current value for the output current I1, and outputs, as a control signal, the target current value for the output current I1 thus obtained to the step-down converter 32 (step S5). When receiving the target current value from the output current setting section 43, the step-down converter 32 starts operating to control the switching element such that the output current I1 has the target current value (step S6). Thus, the output current I1 is controlled to be a current according to the specification of the light source 110. Then, the step-down converter 32 measures the output current I1 and performs constant current control of the output current I1 such that the measurement value is maintained at the target current value (step S7).

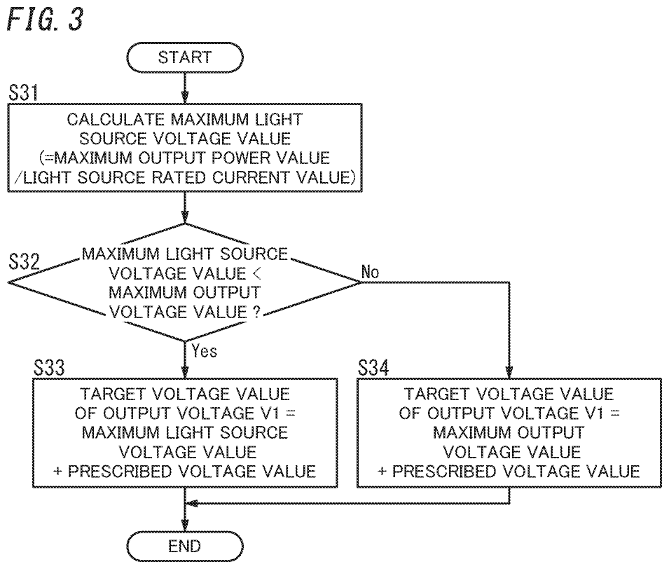

Next, with reference to FIG. 3, a flow of the process (setting of the target voltage value) in step S3 of FIG. 2 will be described.

The step-up voltage setting section 42 divides the maximum output power value which is preset by the light source rated current value to calculate the maximum light source voltage value (step S31). Then, the step-up voltage setting section 42 determines whether or not the maximum light source voltage value thus calculated is smaller than the maximum output voltage value which is preset (step S32). As a result of the determination, if the maximum light source voltage value is smaller than the maximum output voltage value (step S32: Yes), the step-up voltage setting section 42 sets, as the target voltage value, a value obtained by adding a prescribed voltage value to the maximum light source voltage value (step S33). Then, the process ends. On the other hand, if as a result of the determination in step S32, the maximum output voltage value is smaller than the maximum light source voltage value (step S32: No), the step-up voltage setting section 42 sets, as the target voltage value, a value obtained by adding a prescribed voltage value to the maximum output voltage value (step S34). Then, the process ends.

Thus, with the lighting apparatus 1 according to the embodiment, the step-up converter 31 is controlled such that the output voltage V1 changes in accordance with the specification of the light source unit 100. Moreover, the step-down converter 32 is controlled such that the output current I1 is a current according to the specification of the light source unit 100. Thus, when the step-down converter 32 outputs, to the light source unit 100, a current according to the specification of the light source unit 100, it is possible to reduce cases where the output voltage V1 of the step-up converter 31 is a voltage excessively high with respect to the specification of the light source unit 100. Thus, it is possible to reduce circuit loss, as a result of which, for example, a heat dissipation apparatus with high heat dissipation is no longer required, and therefore, downsizing and cost reduction are possible.

Variation

The embodiment is a mere example of various embodiments of the present disclosure. Various modifications may be made to the embodiment depending on design and the like as long as the object of the present disclosure can be achieved. Moreover, an aspect according to the above-described embodiment does not necessarily have to be implemented as a single lighting apparatus 1. The aspect according to the above-described embodiment may be implemented as, for example, a lamp 50 including the lighting apparatus 1, a vehicle K1 including the lamp 50, or a non-transitory computer-readable medium storing a computer program designed to cause at least one processor to execute functions as the lighting apparatus 1.

More specifically, the lamp 50 includes a light source unit 100 and the lighting apparatus 1. The vehicle K1 includes a vehicle body and the lamp 50. The computer program is a computer program designed to cause the at least one processor to execute a step-up conversion process, a step-down conversion process, and a control process. The step-up conversion process is a process of controlling a step-up converter to step up a voltage of a direct-current power supply E1 to obtain an output voltage having a first voltage value and outputting the output voltage. The step-down conversion process is a process of controlling a step-down converter to step down the output voltage of the step-up conversion process to have a second voltage value to output a current having a current value according to the second voltage value to the light source 110. The control process is a process of acquiring information about specification (e.g., light source rated current value) of the light source 110, controlling the step-down converter such that the current value becomes a current value according to the specification of the light source 110, and controlling the step-up converter such that the first voltage value changes in accordance with the specification of the light source 110.

Note that the variations described below may be combined as appropriate.

(First Variation) In the first embodiment, the light source information outputter 120 includes the resistor R10 having a resistance value according to the specification of the light source 110 to hold information about the specification of the light source 110. Note that a method of holding the information by the light source information outputter 120 is not limited to a case of using the resistor R10. For example, the light source information outputter 120 may include nonvolatile memory and may hold information about the specification of the light source unit 100 in the nonvolatile memory. The light source information detector 41 in turn reads the information about the specification of the light source unit 100 from the nonvolatile memory.

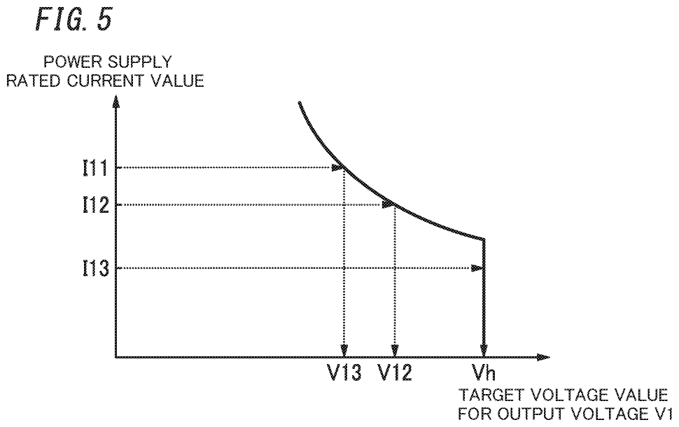

(Second Variation) In the first embodiment, the step-up voltage setting section 42 obtains the target voltage value for the output voltage V1 by calculation based on the value of the maximum output power, the value of the maximum output voltage, and the light source rated current value (the value of the input current). However, the method of obtaining the target voltage value for the output voltage V1 is not limited to this embodiment. For example, as illustrated in FIG. 5, the step-up voltage setting section 42 may hold a correspondence relationship between the light source rated current value and the target voltage value for the output voltage V1. The correspondence relationship may be given as a function formula or a correspondence table. The step-up voltage setting section 42 may obtain the target voltage value for the output voltage V1 from the light source rated current value based on the correspondence relationship. In the example shown in FIG. 5, the relationship between the light source rated current value and the target voltage value for the output voltage V1 is expressed by a hyperbola. Note that in the first embodiment, a prescribed voltage value is added in the course of calculation to obtain the target voltage value, but the hyperbola is a hyperbola offset in a lateral axis direction (parallelly moved) with addition of the prescribed voltage value being taken into consideration.

Moreover, the target voltage value for the output voltage V1 is limited by a value Vh. According to the correspondence relationship, when light source rated current values are values I11, I12, and I13, the target voltage values for the output voltage V1 are values V11, V12, and Vh, respectively.

(Third Variation)

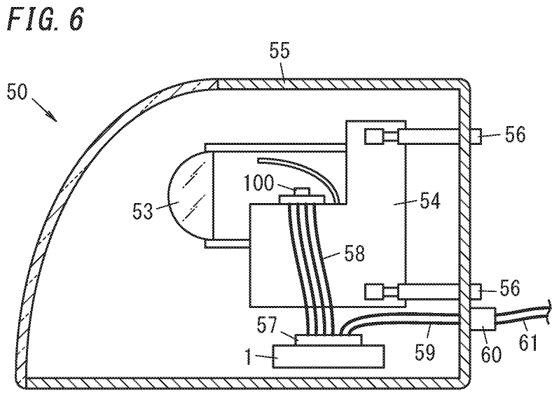

An example of the lamp 50 of the first embodiment will be described. As illustrated in FIG. 6, the lamp 50 includes a lighting apparatus 1, a light source unit 100, an optical unit 53, a heat dissipation unit 54, and a housing 55. The optical unit 53 is an optical component which frontward radiates light output from the light source unit 100. The heat dissipation unit 54 is a component which dissipates heat generated from the light source unit 100. The housing 55 accommodates the lighting apparatus 1, the light source unit 100, the optical unit 53, and the heat dissipation unit 54. More specifically, the heat dissipation unit 54 is fixed with fixing jigs 56 to be spaced away from a rear wall of the housing 55. The light source unit 100 and the optical unit 53 are fixed to the heat dissipation unit 54. The lighting apparatus 1 is disposed, for example, below the heat dissipation unit 54 in the housing 55. The lighting apparatus 1 is connected to a connector 57. The connector 57 is connected to connection lines 58 from the light source unit 100. The connector 57 is also connected to a connection line 59. The connection line 59 has one end connected to a terminal at an outer surface of the housing 55, and the terminal is connected to a connector 60. The connector 60 is connected to a power line 61 from the direct-current power supply E1. In this lamp 50, electric power from the direct-current power supply E1 is input via the power line 61 and the connection line 59 to the lighting apparatus 1 and is output from the lighting apparatus 1 via the connection lines 58 to the light source unit 100.

(Fourth Variation)

In the first embodiment, the target voltage value is a value obtained by adding a prescribed voltage value to the smaller of the value of the maximum output voltage or the voltage value obtained by dividing the value of the maximum output power by the value of the input current. However, the target voltage value may be the smaller of the value of the maximum output voltage or the voltage value. Also in this case, it is possible to obtain a target voltage value with the light source rated current value being taken into consideration. Note that in this variation, the value of the maximum output power may be set to a value larger than the value of the maximum output power in the first embodiment. As compared to a case of the first embodiment, a prescribed voltage value is not added in the course of calculation of the target voltage value, but as described above, setting the value of the maximum output power to a value larger than the value of the maximum output power in the first embodiment enables the same effect as that obtained by adding the prescribed voltage value to be obtained.

### Second Embodiment

In the following description, differences from the first embodiment will be mainly described, and the same components as those in the first embodiment are denoted by the same reference signs, and the description thereof will be omitted in some cases.

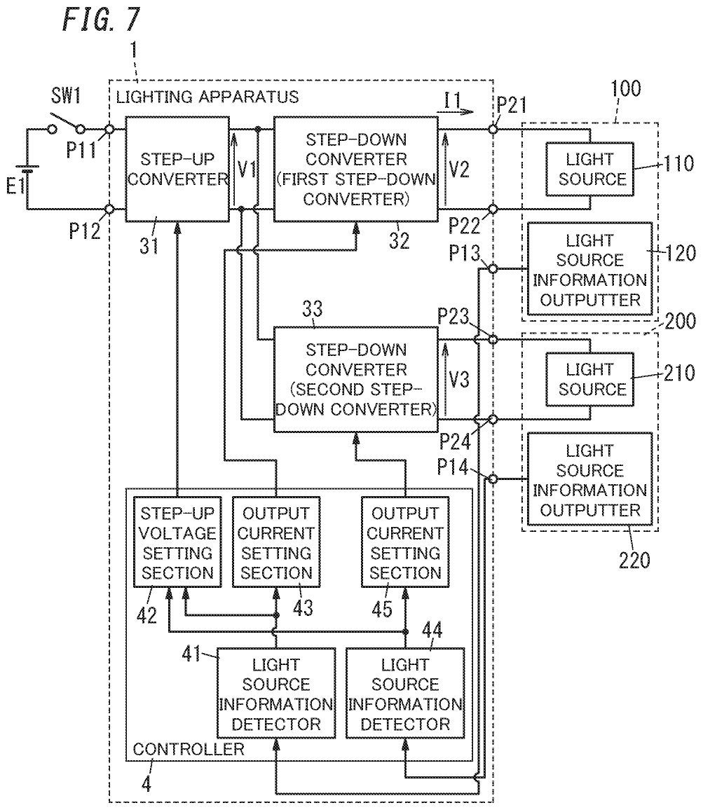

As illustrated in FIG. 7, a lighting apparatus 1 according to the present embodiment corresponds to the lighting apparatus of the first embodiment further including a step-down converter 33. That is, the lighting apparatus 1 according to the present embodiment includes two step-down converters 32 and 33. The step-down converter 32 is hereinafter also referred to as a first step-down converter 32, and the step-down converter 33 is also referred to as a second step-down converter 33.

The lighting apparatus 1 according to the present embodiment further includes a fourth input terminal P14, a third output terminal P23, and a fourth output terminal P24. The third output terminal P23 and the fourth output terminal P24 are electrically connected to two output ends of the second step-down converter 33. The fourth input terminal P14 is electrically connected to a light source information detector 44 of a controller 4. The light source information detector 44 will be described later.

The two step-down converters 32 and 33 correspond to light source units 100 and 200 different from each other on a one-to-one basis and each output a voltage and a current to a corresponding one of the light source unit 100 and the light source unit 200. The light source unit 200 has the same configuration as the light source unit 100 except for the specification. The light source unit 200 includes a light source 210 and a light source information outputter 220. The light source information outputter 220 outputs light source information of the light source unit 200. The light source 210 is electrically connected between the third output terminal P23 and the fourth output terminal P24. The light source information outputter 220 is electrically connected to the fourth input terminal P14. The light source information of the light source unit 100 is hereinafter also referred to as first light source information, and the light source information of the light source unit 200 is also referred to as second light source information. Moreover, the light source rated current value of the light source 110 is also referred to as a first light source rated current value, and the light source rated current value of the light source 210 is also referred to as a second light source rated current value.

An output voltage V1 of a step-up converter 31 is output to the two step-down converters 32 and 33. Since the first step-down converter 32 is the same as that in the first embodiment, the detailed description thereof will be omitted. The second step-down converter 33 steps down the output voltage V1 of the step-up converter 31 from the first voltage value to a third voltage value to obtain an output voltage V3, and the step-down converter 32 outputs the output voltage V3 to the light source 210. Thus, the step-down converter 33 outputs, to the light source 210, an output current I2 having a second current value according to the third voltage value.

The controller 4 of the present embodiment corresponds to the controller 4 of the first embodiment further including the light source information detector 44 and an output current setting section 45. That is, the controller 4 of the present embodiment includes two light source information detector, namely, a light source information detector 41 and the light source information detector 44, the step-up converter 31, and the two step-down converters 32 and 33. The light source information detector 41 and the output current setting section 43 are the same as the light source information detector 41 and the output current setting section 43 of the first embodiment, and thus, the description thereof will be omitted.

The light source information detector 44 has a similar configuration to that of the light source information detector 41. The light source information detector 44 detects second light source information from the light source unit 200, acquires, from the second light source information thus detected, information (e.g., second light source rated current value) about the specification of the light source 210 (specification of the light source unit 200), and outputs the second light source rated current value thus acquired to the step-up voltage setting section 42 and the output current setting section 45.

The output current setting section 45 obtains, based on the second light source rated current value from the light source information detector 44, a target current value for the output current I2 of the second step-down converter 33 and outputs, as a control signal, the target current value thus obtained to the second step-down converter 33. Meanwhile, in the second step-down converter 33, for example, the driver IC controls turning on/off of the switching element such that the output current I2 of the second step-down converter 33 has the target current value. The target current value for the output current I1 is hereinafter also referred to as a first target current value, and the target current value for the output current I2 is also referred to as a second target current value.

The step-up voltage setting section 42 acquires a first light source rated current value from the light source information detector 41 and acquires a second light source rated current value from the light source information detector 44. Then, the step-up voltage setting section 42 obtains, based on the first light source rated current value and the second light source rated current value, a target voltage value for the output voltage V1 of the step-up converter 31 and outputs, as a control signal, the target voltage value thus obtained to the step-up converter 31. Meanwhile, in the step-up converter 31, for example, the driver IC controls turning on/off of the switching element such that the output voltage V1 of the step-up converter 31 has the target voltage value. The target voltage value is obtained based on both the first light source rated current value and the second light source rated current value, and therefore, it is possible to reduce cases where the output voltage V1 of the step-up converter 31 is a voltage excessively high with respect to each of the specification of the light source 110 and the specification of the light source 210.

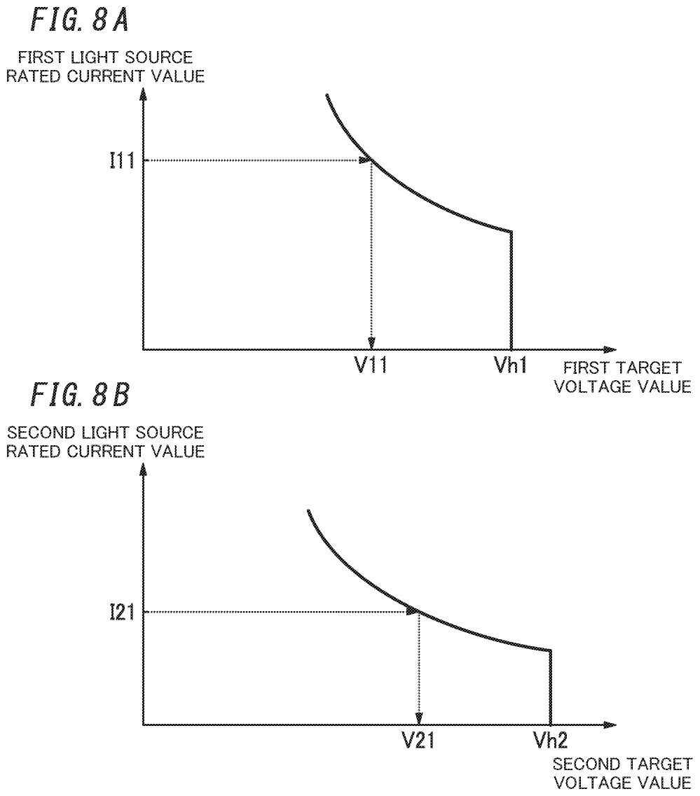

Specifically, the step-up voltage setting section 42 obtains the target voltage value for the output voltage V1 of the step-up converter 31 as described below. The step-up voltage setting section 42 obtains, based on the first light source rated current value from the light source information detector 41, the target voltage value for the output voltage V1 of the step-up converter 31 suitable to the specification of the light source 110 (hereinafter referred to as a first target voltage value). Specifically, the step-up voltage setting section 42 has a correspondence relationship between the first light source rated current value and the first target voltage value as illustrated in FIG. 8A. The correspondence relationship is given as, for example, a function formula or a correspondence table. The step-up voltage setting section 42 obtains, based on the correspondence relationship, the first target voltage value from the first light source rated current value acquired from the light source information detector 41. For example, form the correspondence relationship, a value V11 is obtained as the first target voltage value when the first light source rated current value is a value I11

The step-up voltage setting section 42 obtains, based on the second light source rated current value from the light source information detector 44, a target voltage value for the output voltage V1 of the step-up converter 31 suitable to the specification of the light source 210 (hereinafter referred to as a second target voltage value). Specifically, the step-up voltage setting section 42 has a correspondence relationship between the second light source rated current value and the second target voltage value as illustrated in FIG. 8B. The correspondence relationship is given as, for example, a function formula or a correspondence table. The step-up voltage setting section 42 obtains, based on the correspondence relationship, the second target voltage value from the second light source rated current value acquired from the light source information detector 44. For example, form the correspondence relationship, a value V21 is obtained as the second target voltage value when the second light source rated current value is a value I21.

The step-up voltage setting section 42 sets, as the target voltage value (a maximum target voltage value) for the output voltage V1 of the step-up converter 31, the larger of the first target voltage value or the second target voltage value thus obtained (i.e., a maximum value).

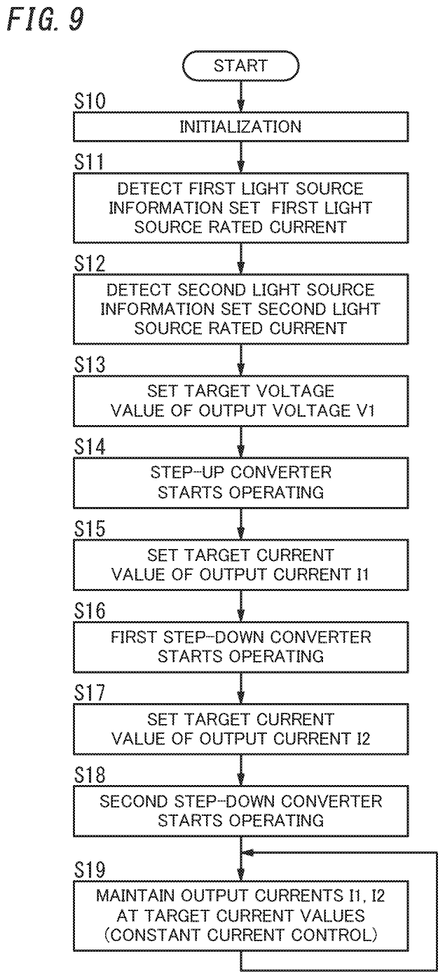

Next, with reference to FIG. 9, operation of the lighting apparatus 1 according to the present embodiment will be described.

When a driver of a vehicle turns on the power supply switch SW1 to supply electric power from the direct-current power supply E1 to the lighting apparatus 1, the controller 4 performs initialization processing (step S10). Then, the light source information detector 41 detects, from the light source information outputter 120 of the light source unit 100, the first light source information, and acquires the first light source rated current value from the first light source information thus detected. The light source information detector 41 then outputs the first light source rated current value to the step-up voltage setting section 42 and the output current setting section 43 (step S11). Then, the light source information detector 44 detects, from the light source information outputter 220 of the light source unit 200, the second light source information, and acquires the second light source rated current value from the second light source information thus detected. The light source information detector 44 then outputs the second light source rated current value to the step-up voltage setting section 42 and the output current setting section 45 (step S12).

Then, the step-up voltage setting section 42 obtains, based on the first light source rated current value from the light source information detector 41 and the second light source rated current value from the light source information detector 44, the target voltage value for the output voltage V1, and outputs, as a control signal, the target voltage value for the output voltage V1 thus obtained to the step-up converter 31 (step S13).

When receiving the target voltage value for the output voltage V1 from the step-up voltage setting section 42, the step-up converter 31 starts operating to control the switching element such that the output voltage V1 has the target voltage value (step S14). Thus, the output voltage V1 changes in accordance with the specification of the light source 110. Thus, it is possible to reduce cases where the output voltage V1 of the step-up converter 31 is a voltage excessively high with respect to each of the specification of the light source 110 and the specification of the light source 210.

The output current setting section 43 obtains, based on the first light source rated current value from the light source information detector 41, the target current value for the output current I1, and outputs, as a control signal, the target current value thus obtained to the first step-down converter 32 (step S15). When receiving the target current value for the output current I1 from the output current setting section 43, the step-down converter 32 starts operating to control the switching element such that the output current I1 has the target current value (step S16). Thus, the output current I1 is controlled to be a current according to the specification (first light source rated current value) of the light source 110.

Then, the output current setting section 45 obtains, based on the second light source rated current value from the light source information detector 44, the target current value for the output current I2, and outputs, as a control signal, the target current value thus obtained to the second step-down converter 33 (step S17). When receiving the target current value for the output current I2 from the output current setting section 45, the second step-down converter 33 starts operating to control the switching element such that the output current I2 has the target current value (step S18). Thus, the output current I2 is controlled to be a current according to the specification (e.g., second light source rated current value) of the light source 210.

Then, the first step-down converter 32 measures the output current I1 and performs an update by increasing or reducing the target current value for the output current I1 such that variation of the measurement value is canceled. Moreover, the second step-down converter 33 measures the output current I2 and performs constant current control of the output current I2 such that the measurement value maintains the target current value (step S19).

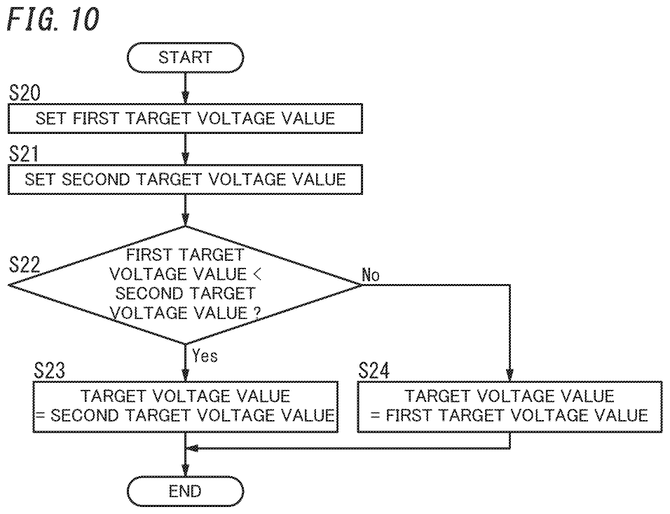

Next, with reference to FIG. 10, a flow of the process in step S13 in FIG. 9 will be described.

The step-up voltage setting section 42 obtains, for example, based on the correspondence relationship in FIG. 8A, a first target voltage value for the output voltage V1 suitable to the specification of the light source 110 from the first light source rated current value (step S20). The step-up voltage setting section 42 further obtains, for example, based on the correspondence relationship in FIG. 8B, a second target voltage value for the output voltage V1 suitable to the specification of the light source 210 from the second light source rated current value (step S21). The step-up voltage setting section 42 then determines whether or not the second target voltage value is larger than the first target voltage value (step S22). As a result of the determination, if the second target voltage value is larger than the first target voltage value (step S22: Yes), the step-up voltage setting section 42 sets the second target voltage value to the target voltage value of the output voltage V1 (step S23). On the other hand, as a result of the determination in step S22, if the first target voltage value is larger than the second target voltage value (step S22: No), the step-up voltage setting section 42 sets the first target voltage value to the target voltage value for the output voltage V1 (step S24).

As described above, with the lighting apparatus 1 according to the embodiment, also when the two step-down converters 32 and 33 which supply electric power to the light source units 100 and 200 different from each other are provided, it is possible to reduce cases where the output voltage V1 of the step-up converter 31 is a voltage excessively high with respect to the specification of each of the two light source units 100 and 200.

Note that the lighting apparatus 1 of the present embodiment includes the two step-down converters 32 and 33 but may include three or more step-down converters. In this case, the three or more step-down converters correspond to three of more light source units on a one-to-one basis and each outputs a voltage and a current to a corresponding one of the light source units.

### SUMMARY

A lighting apparatus (1) according to one aspect includes a step-up converter (31), at least one step-down converter (32), and a controller (4). The step-up converter (31) is configured to step up a voltage of a direct-current power supply (E1) to obtain an output voltage having a first voltage value and output the output voltage. The at least one step-down converter (32) is configured to step down the output voltage of the step-up converter (31) to have a second voltage value to output a current having a current value according to the second voltage value to a light source (110). The controller (4) is configured to acquire information about a specification of the light source (110), control the at least one step-down converter (32) such that the current value becomes a current value according to the specification, and control the step-up converter (31) such that the first voltage value varies in accordance with the specification.

With this configuration, the step-up converter (31) is controlled such that the first voltage value changes in accordance with the specification of the light source (110), and the step-down converter (32) is controlled such that the current value becomes a current value according to the specification of the light source (110). Thus, when the step-down converter (32) outputs a current according to the specification of the light source (110) to the light source (110), it is possible to reduce cases where the output voltage (V1) of the step-up converter (31) is a voltage excessively high with respect to the specification of the light source (110). This enables circuit loss to be reduced, and downsizing and cost reduction are possible.

In a lighting apparatus (1) of a second aspect referring to the first aspect, the specification includes a value of an input current to the light source (110).

With this configuration, it is possible to control the first voltage value with the input current to the light source (110) being taken into consideration.

In a lighting apparatus (1) of a third aspect referring to the second aspect, the controller (4) sets a target voltage value based on a value of a maximum output voltage, a value of maximum output power, and the value of the input current and controls the step-up converter (31) such that the first voltage value becomes the target voltage value. The value of the maximum output voltage is a value output to the light source (110). The value of the maximum output power is a value output to the light source (110).

With this configuration, it is possible to obtain a target voltage value according to the input current serving as the specification of the light source (110).

In a lighting apparatus (1) of a fourth aspect referring to the third aspect, the controller (4) sets the target voltage value to a smaller of the value of the maximum output voltage or a voltage value obtained by dividing the value of the maximum output power by the value of the input current.

With this configuration, it is possible to set the target voltage value to a voltage according to the specification of the light source (110). Thus, it is possible to control the output voltage (V1) of the step-up converter (31) to a voltage which is not excessively high with respect to the specification of the light source (110).

In a lighting apparatus (1) of a fifth aspect referring to the third aspect, the controller (4) sets the target voltage value to a value obtained by adding a prescribed voltage value to a smaller of the value of the maximum output voltage or a voltage value obtained by dividing the value of the maximum output power by the value of the input current.

With this configuration, it is possible to set the target voltage value to a voltage which is higher than a voltage according to the specification of the light source (110) by the prescribed voltage value. Thus, it is possible to control the output voltage (V1) of the step-up converter (31) to a voltage which is not excessively high with respect to the specification of the light source (110).

In a lighting apparatus of a sixth aspect referring to the first aspect, the controller (4) includes a light source information detector (41), a step-up voltage setting section (42), and a output current setting section (43). The light source information detector (41) is configured to acquire the information about the specification of the light source (110). The step-up voltage setting section (42) is configured to generate, based on the information acquired by the light source information detector (41), a target voltage value for the output voltage (V1) of the step-up converter (31) and output the target voltage value thus generated to the step-up converter (31). The output current setting section (43) is configured to generate, based on the information acquired by the light source information detector (41), a target current value for an output current (I1) of the at least one step-down converter (32) and output the target current value thus generated to the at least one step-down converter (32).

In a lighting apparatus (1) of a seventh aspect referring to the fourth or fifth aspect, the at least one step-down converter includes a plurality of step-down converters. The plurality of step-down converters (32, 33) correspond to a plurality of light source units (100, 200) and each output a current to a corresponding one of the light sources (110, 210). The controller (4) obtains target voltage values each corresponding to an associated one of the plurality of light sources (110, 210) and sets, as a maximum target voltage value, a maximum value of the target voltage values thus obtained. The controller (4) controls the step-up converter (31) such that the output voltage (V1) of the step-up converter (31) has the maximum target voltage value.

With this configuration, also when a plurality of step-down converters (32, 33) configured to supply electric power to light sources (110) different from each other are provided, it is possible to reduce cases where the output voltage (V1) of the step-up converter (31) is a voltage excessively high with respect to the specification of each of the plurality of light sources (110).

In a lighting apparatus of an eighth aspect referring to the seventh aspect, the controller (4) includes a plurality of light source information detectors (41, 44), a step-up voltage setting section (42), and a plurality of output current setting sections (43, 45). The plurality of light source information detectors (41, 44) are each configured to acquire a piece of information about the specification of a corresponding one of the plurality of light sources (110, 210). The step-up voltage setting section (42) is configured to generate, based on the pieces of information acquired by the plurality of light source information detectors (41, 44), a target voltage value for the output voltage (V1) of the step-up converter (31) and output the target voltage value thus generated to the step-up converter (31). The plurality of output current setting sections (43, 45) corresponds to the plurality of step-down converters (32, 33) on a one-to-one basis and corresponds to the plurality of light source information detectors (41, 44) on a one-to-one basis. The plurality of output current setting sections (43, 45) are each configured to generate, based on the piece of information acquired from a corresponding one of the plurality of light source information detectors (41, 44), a target current value for the output current (I1, I2) of a corresponding one of the step-down converters (32, 33) and output the target current value thus generated to a corresponding one of the plurality of step-down converters (32, 33).

A lamp (50) of a ninth aspect includes the lighting apparatus (1) of any one of the first to eighth aspects and the light source (110).

With this configuration, it is possible to provide the lamp (50) having an effect of the lighting apparatus (1).

A lamp of a tenth aspect referring to the ninth aspect further includes an optical unit (53), a heat dissipation unit (54), and a housing. The optical unit (53) is configured to radiate light output from the light source (110, 210) frontward. The heat dissipation unit (54) is configured to dissipate heat generated from the light source (110, 210). The housing (55) accommodates the lighting apparatus (1), the light source (110, 210), the optical unit (53), and the heat dissipation unit (54).

A vehicle (K1) of an eleventh aspect includes the lamp (50) of the ninth aspect and a vehicle body. The lamp (50) is mounted on the vehicle body.

With this configuration, it is possible to provide the vehicle (K1) having an effect of the lamp (50).

A non-transitory computer-readable medium of a twelfth aspect is a non-transitory computer-readable medium storing a computer program designed to cause at least one processor to execute a step-up conversion process, a step-down conversion process, and a control process. The step-up conversion process is a step of controlling a step-up converter to step up a voltage of a direct-current power supply (E1) to obtain an output voltage having a first voltage value and output the output voltage. The step-down conversion process is a step of controlling a step-down converter to step down the output voltage of the step-up conversion process to have a second voltage value to output a current having a current value according to the second voltage value to the light source (110). The control process is a step of acquiring information about a specification of the light source (110), controlling the step-down converter such that the current value becomes a current value according to the specification, and controlling the step-up converter such that the first voltage value changes in accordance with the specification.

With this configuration, it is possible to provide a non-transitory computer-readable medium storing a computer program for execution of functions as the lighting apparatus (1).

While various embodiments have been described herein above, it is to be appreciated that various changes in form and detail may be made without departing from the spirit and scope of the present disclosure presently or hereafter claimed.

1. A lighting apparatus, comprising:
a step-up converter configured to step up a voltage of a direct-current power supply to obtain an output voltage having a first voltage value and output the output voltage;
at least one step-down converter configured to step down the output voltage of the step-up converter to have a second voltage value to output a current having a current value according to the second voltage value to a light source; and
a controller configured to acquire information about a specification of the light source, control the at least one step-down converter such that the current value becomes a current value according to the specification, and control the step-up converter such that the first voltage value varies in accordance with the specification.

2. The lighting apparatus of claim 1, wherein
the specification includes a value of an input current to the light source.

3. The lighting apparatus of claim 2, wherein
the controller sets a target voltage value based on a value of a maximum output voltage output to the light source, a value of maximum output power output to the light source, and the value of the input current, and controls the step-up converter such that the first voltage value becomes the target voltage value.

4. The lighting apparatus of claim 3, wherein
the controller sets the target voltage value to a smaller of the value of the maximum output voltage or a voltage value obtained by dividing the value of the maximum output power by the value of the input current.

5. The lighting apparatus of claim 3, wherein
the controller sets the target voltage value to a value obtained by adding a prescribed voltage value to a smaller of the value of the maximum output voltage or a voltage value obtained by dividing the value of the maximum output power by the value of the input current.

6. The lighting apparatus of claim 1, wherein
the controller includes
a light source information detector configured to acquire the information about the specification of the light source,
a step-up voltage setting section configured to generate, based on the information acquired by the light source information detector, a target voltage value for the output voltage of the step-up converter and output the target voltage value thus generated to the step-up converter, and
an output current setting section configured to generate, based on the information acquired by the light source information detector, a target current value for an output current of the at least one step-down converter and output the target current value thus generated to the at least one step-down converter.

7. The lighting apparatus of claim 4, wherein
the at least one step-down converter includes a plurality of step-down converters,
the plurality of step-down converters correspond to a plurality of light sources and each output a current to a corresponding one of the plurality of light sources, and
the controller obtains the target voltage values for the plurality of light sources, sets, as a maximum target voltage value, a maximum value of the target voltage values thus obtained, and controls the step-up converter such that the first voltage value becomes the maximum target voltage value.

8. The lighting apparatus of claim 7, wherein
the controller includes
a plurality of light source information detectors each configured to acquire a piece of information about the specification of a corresponding one of the plurality of light sources,
a step-up voltage setting section configured to generate, based on the pieces of information acquired by the plurality of light source information detectors, a target voltage value for the output voltage of the step-up converter and output the target voltage value thus generated to the step-up converter,
a plurality of output current setting sections corresponding to the plurality of step-down converters on a one-to-one basis and corresponding to the plurality of light source information detectors on a one-to-one basis, and
the plurality of output current setting sections are each configured to generate, based on the piece of information acquired from a corresponding one of the plurality of light source information detectors, a target current value for the output current of a corresponding one of the step-down converters and output the target current value thus generated to a corresponding one of the plurality of step-down converters.

9. A lamp, comprising:
the lighting apparatus of claim 1; and
the light source.

10. The lamp of claim 9, further comprising
an optical unit configured to radiate light output from the light source frontward,
a heat dissipation unit configured to dissipate heat generated from the light source, and
a housing accommodating the lighting apparatus, the light source, the optical unit, and the heat dissipation unit.

11. A vehicle, comprising:
the lamp of claim 9; and
a vehicle body on which the lamp is mounted.

12. A non-transitory computer-readable medium storing a computer program designed to cause at least one processor to execute:
a step-up conversion process of controlling a step-up converter to step up a voltage of a direct-current power supply to obtain an output voltage having a first voltage value;
a step-down conversion process of controlling a step-down converter to step down the output voltage of the step-up conversion process to have a second voltage value to output a current having a current value according to the second voltage value to the light source; and
a control process of acquiring information about a specification of the light source, controlling the step-down converter such that the current value becomes a current value according to the specification, and controlling the step-up converter such that the first voltage value changes in accordance with the specification.
